(19) United States
(12) Patent Application Publication
(10) Pub. No.: US 2009/0212509 A1
(43) Pub. Date: Aug. 27, 2009

(54) Ride Level Control Device of a Vehicle

(76) Inventors: Falk Hecker, Markgröningen (DE); Ulrich Gücker, Schwieberdingen (DE)

Correspondence Address: KENYON & KENYON LLP, ONE BROADWAY, NEW YORK, NY, 10004, US

(21) Appl. No.: 11/918,025

(22) PCT Filed: Mar. 28, 2006
(86) PCT No.: PCT/EP2006/002801

§ 371 Date: Dec. 3, 2008

(30) Foreign Application Priority Data
Apr. 4, 2005 (DE) 10 2005 015 285.6

(51) Int. Cl. B60G 17/019

(52) U.S. Cl. 280/5.503

(57) ABSTRACT

A level control device of a vehicle may include an angle-of-rotation sensor for measuring the distance between a vehicle chassis and a vehicle axle or wheel according to an inductive principle. The sensor may include an electrical coil that has a coil core for generating a magnetic field, and at least one eccentric body capable of swiveling about an axis of rotation as a function of the distance. The coil core may be disposed in a stationary manner relative to the coil the eccentric body may be made of a ferromagnetic material and captured at least partially by the lines of force of the magnetic field of the coil in such a way that, solely by a change of its position relative to the coil core, a change of the inductivity of the coil is brought about as a measure for a change of the distance.

### FIELD OF THE INVENTION

The present invention relates to a level control device of a vehicle, in particular of a commercial vehicle, including an angle-of-rotation sensor for measuring the distance between a vehicle chassis and a vehicle axle or a vehicle wheel according to an inductive principle.

### BACKGROUND INFORMATION

A level control device as described in EP 0 213 267 A2, includes a displacement sensor that has a coil, a core disposed so as to be movable relative to the coil, and an actuating device for the core, by which the core is moved as a function of the rotary motion of a shaft in the direction of its longitudinal axis. A crankgear is used as the actuating device for the core, which is mechanically linked on one side to the shaft and on the other side to the core. Via an axle, the core is connected in an articulated manner to a lever of the crankgear that acts as a connecting rod. The axle is supported in a guidance element situated coaxially with respect to the core. This set-up is disadvantageous, however, in that it has relatively many components and is thus costly to manufacture.

### SUMMARY OF THE INVENTION

By contrast, the present invention is based on the objective of refining a level control device in such a way that it is constructed in a simpler manner and more cost-effective to manufacture.

Example embodiments of the present invention provide a level control device of a vehicle, in particular of a commercial vehicle, including an angle-of-rotation sensor for measuring the distance between a vehicle chassis and a vehicle axle or a vehicle wheel according to an inductive principle, where the sensor includes an electrical coil that has a coil core for generating a magnetic field; and at least one eccentric body, which is capable of swiveling about an axis of rotation as a function of the distance.

Example embodiments of the present invention may provide for disposing the coil core not, as in the related art, so that it is longitudinally displaceable relative to the coil, but rather in a stationary manner, i.e., in a fixed manner relative to the coil. A change of the inductivity of the coil as a measure for a change of the distance between a vehicle chassis and a vehicle axle or a vehicle wheel may then be achieved. For this purpose, the eccentric body may be made from a ferromagnetic material and may be at least partially captured by the lines of force of the magnetic field of the coil in such a way that the change of the inductivity of the coil is brought about solely by a change of its position relative to the coil core. A costly crankgear and/or a configuration that provides the ability of the coil core to move longitudinally relative to the coil may therefore be dispensed with, for the change of the inductivity results solely from the relative motion of the eccentric body relative to the coil. In other words, the volume of the coil core may be expanded or reduced by the eccentric body that is disposed separately from it and in a rotatable manner, the eccentric body consequently being able to swivel with respect to the coil core in such a way that, as a function of its rotational position, it is captured by the magnetic field with a variable portion of its volume. In order to obtain a sensitivity and linearity sufficient for a measurement, the eccentric body may be captured by the lines of force of the magnetic field to a sufficient degree, which one skilled in the art may achieve by a suitable adaptation of the geometries and distances.

According to an embodiment of the present invention, the axis of rotation of the eccentric body may be situated in a plane perpendicular to a center axis of the coil core, the eccentric body containing at least one plate that is capable of swiveling in a plane containing the center axis of the coil core. For the eccentric body to be able to dip at least partially into a coil opening, the surface of the coil core facing the eccentric body may be disposed offset a bit axially toward the interior with respect to an end face of the coil.

According to an alternative example embodiment of the present invention, the axis of rotation of the eccentric body may be situated parallel to a center axis of the coil core, the eccentric body including at least one plate that is capable of swiveling in a plane that is parallel to an end face of the coil core, which plate, as a function of its rotational position, has a varying degree of overlap with the end face of the coil core.

### BRIEF DESCRIPTION OF THE DRAWINGS

FIG. 1 is a cross-sectional representation of an angle-of-rotation sensor of a level control device of a commercial vehicle, according to an example embodiment of the present invention.

FIG. 2 is a cross-sectional representation of an angle-of-rotation sensor of a level control device of a commercial vehicle, according to an alternative example embodiment of the present invention.

### DETAILED DESCRIPTION OF THE INVENTION

The figures show exemplary embodiments of a angle-of-rotation sensor 1 of a level control device of a commercial vehicle according to example embodiments of the present invention. In this instance, the measuring principle is based on measuring the change of the inductivity of an electric coil 2 by the introduction of an eccentric body 4 into the lines of force of the magnetic field generated by it.

The inductivity of such a coil 2 may be calculated in accordance with equation (1) as follows:

$$L = \frac{{N}^{2} \cdot μ \cdot A}{s} \qquad ( 1 )$$

where:
N is the number of windings of the coil;
s is the path length of the magnetic lines of force;
A is the area permeated by the magnetic lines of force; and
μ is the permeability of the material of the coil core.

The inductivity may therefore be changed by introducing materials of varying permeability into the magnetic circuit. Example embodiments of the present invention may provide for disposing coil core 6, which is associated with the coil, in a stationary manner, i.e., in a fixed manner relative to coil 2. Coil core 6 may be cylindrical, made of a ferromagnetic material, and surrounded at least partially by coil 2.

A change of the inductivity of coil 2 as a measure for a change of the distance between a vehicle chassis and a vehicle axle or a vehicle wheel is then achieved in that the eccentric body 4, disposed separately from coil core 6 and rotatable about an axis of rotation 8, expands or reduces coil core 6 in that it is capable of swiveling with respect to coil core 6 in such a way that, as a function of its rotational position, it is captured by the magnetic field with a varying portion of its volume. This means that, solely by a change of its position relative to coil core 6, a change of the inductivity of the coil is brought about as a measure for a change of the distance. The permeability of ferromagnetic materials such as iron, cobalt, or nickel is considerably greater than 1, such that the magnetic field is substantially strengthened when such an eccentric body 4 is captured by the magnetic lines of force.

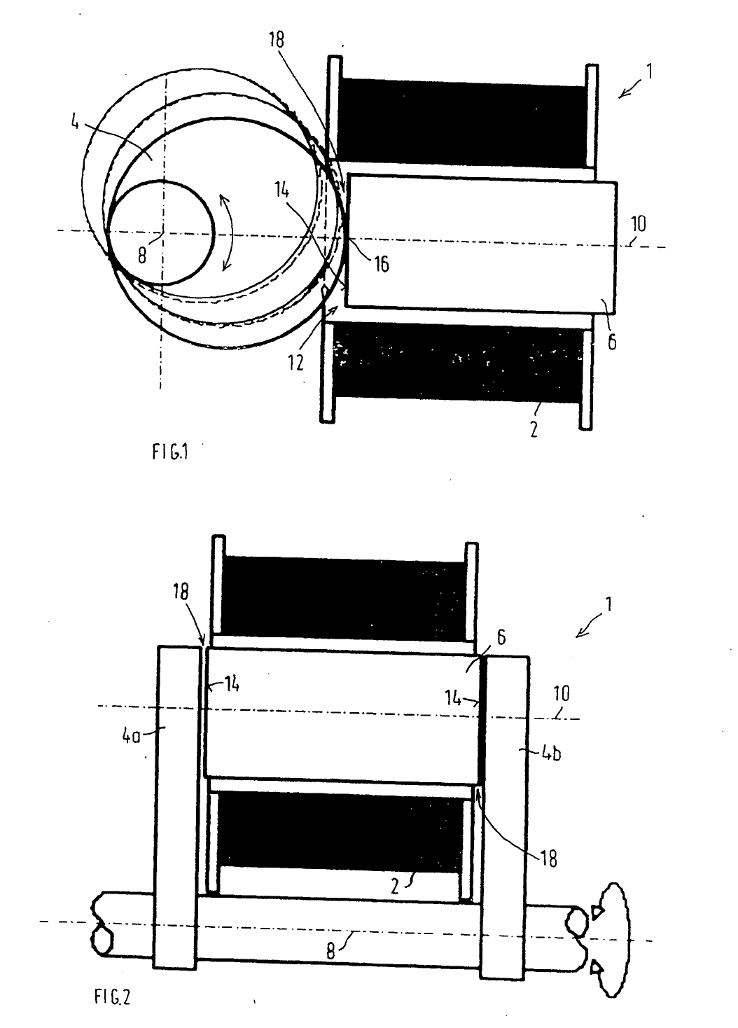

According to an example embodiment of the present invention as shown in FIG. 1, axis of rotation 8 of eccentric body 4 may be situated in a plane perpendicular to a center axis 10 of coil core 6 or of coil 2, the eccentric body including at least one, for example circular, plate 4 capable of swiveling in a plane containing center axis 10. The various swiveling positions of plate 4 are shown in FIG. 1. For plate 4 to be able to dip at least partially into a coil opening 12 of coil 2, coil core 6, for example, is disposed offset a bit axially toward the interior with respect an end face of coil 2.

According to an alternative example embodiment of the present invention as shown in FIG. 2, axis of rotation 8 of eccentric body 4a, 4b may be situated parallel to center axis 10 of coil core 6 or coil 2, the eccentric body including, for example, two likewise circular plates 4a, 4b, capable of swiveling in parallel planes in relation to end faces 14 of coil core 6, which plates have, depending on their rotational position, a varying degree of overlap with end faces 14 of coil core 6. Thus, in this case, coil core 6 is disposed between the two eccentric plates 4a, 4b.

According to either of the alternative example embodiments, the example embodiments may further provide that at least an air gap just large enough that eccentric body 4, 4a, 4b does not contact coil core 6 must remain between eccentric body 4, 4a, 4b and coil core 6. For the exemplary embodiment shown in FIG. 1, this means that, between point 16 of circular plate 4 most distant from axis of rotation 8 and end face 14 of coil core 6, a small air gap still exists when this point 16 in the shown horizontal rotational position of plate 4 indicated by a solid line has a minimal distance from coil core 6. On the other hand, the two plates 4a, 4b framing coil core 6 are, independently of their rotational position, always at a small distance in the form of a small air gap 18 from the opposite end faces 14 of coil core 6.

1-8. (canceled)

9. A level control device of a vehicle, comprising:
an angle-of-rotation sensor configured to measure a distance between a vehicle chassis and one of a vehicle axle and a vehicle wheel the angle-of-rotation sensor including:
an electrical coil that has a coil core for generating a magnetic field; and
at least one eccentric body configured to swivel about an axis of rotation as a function of the distance, wherein:
the coil core is disposed in a stationary manner relative to the coil; and
the at least one eccentric body is made of a ferromagnetic material and is at least partially captured by lines of force of the magnetic field of the coil such that a change of a position of the at least one eccentric body relative to the coil core causes a change in an inductivity of the coil, the change in the inductivity corresponding to a change in the distance.

10. The level control device as recited in claim 9, wherein the at least one eccentric body is configured to swivel with respect to the coil core such that, as a function of variations in a rotational position of the at least one eccentric body, the at least one eccentric body is captured by the magnetic field with a varying portion of its volume.

11. The level control device as recited in claim 9, wherein the at least one eccentric body is positioned to maintain an air gap between the at least eccentric body and the coil core large enough to prevent the at least one eccentric body from contacting the coil core.

12. The level control system as recited in claim 9, wherein the axis of rotation is situated in a plane perpendicular to a center axis of the coil core.

13. The level control device as recited in claim 12, wherein the at least one eccentric body includes at least one plate configured to swivel in a plane containing the center axis of the coil core.

14. The level control device as recited in claim 13, wherein the coil core is disposed offset axially toward an interior with respect to an end face of the coil, the offset allowing the at least one eccentric body to dip into a coil opening in the end face.

15. The level control device as recited in claims 9, wherein the axis of rotation is situated parallel to a center axis of the coil core.

16. The level control device as recited in claim 15, wherein:
the at least one eccentric body includes at least one plate configured to swivel in a plane that is parallel to an end face of the coil core; and
the at least one plate has, as a function of variations in a rotational position of the at least one plate, a varying degree of overlap with the end face of the coil core.

17. The level control device as recited in claim 10, wherein the at least one eccentric body is positioned to maintain an air gap between the at least eccentric body and the coil core large enough to prevent the at least one eccentric body from contacting the coil core.

18. The level control system as recited in claim 17, wherein the axis of rotation is situated in a plane perpendicular to a center axis of the coil core.

19. The level control device as recited in claims 17, wherein the axis of rotation is situated parallel to a center axis of the coil core.

20. The level control system as recited in claim 10, wherein the axis of rotation is situated in a plane perpendicular to a center axis of the coil core.

21. The level control device as recited in claims 10, wherein the axis of rotation is situated parallel to a center axis of the coil core.

22. The level control system as recited in claim 11, wherein the axis of rotation is situated in a plane perpendicular to a center axis of the coil core.

23. The level control device as recited in claims 11, wherein the axis of rotation is situated parallel to a center axis of the coil core.
